(19) United States
(12) Patent Application Publication
(10) Pub. No.: US 2022/0275643 A1
(43) Pub. Date: Sep. 1, 2022

(54) FOAM PANEL WITH DRAINAGE PLANE

(71) Applicant: Ox Engineered Products, LLC, Northville, MI (US)

(72) Inventor: Sarah Overman, Berkley, MI (US)

(73) Assignee: Ox Engineered Products, LLC, Northville, MI (US)

(21) Appl. No.: 17/747,508

(22) Filed: May 18, 2022

Related U.S. Application Data
(60) Provisional application No. 62/906,998, filed on Sep. 27, 2019.

(51) Int. Cl. E04C 2/20

(52) U.S. Cl. CPC E04C 2/205; E04C 2002/3411

(57) ABSTRACT

A method of forming a building panel includes embossing dimples into a sheet, where the dimples extend outward from a plane, and expanding a foam core onto the plane and into portions of the dimples. The method may include forming dimples that are convex relative to the plane and the foam core or the sheet having a thin foil having a plastic protective coating. The method may include attaching a cellulosic layer to the foam core opposite the plane. Additionally, flow channels may be formed in the sheet between the dimples, such that expanding the foam core onto the plane substantially fills both the dimples and the flow channels. The method may include embossing concave dimples onto the plane and the foam core, such that expanding the foam core onto the plane substantially fills the concave dimples. The foam core and sheet may bond without adhesives.

### CROSS REFERENCE TO RELATED APPLICATIONS

This application is a divisional of U.S. Non-Provisional patent application Ser. No. 17/028,541, filed 22 Sep. 2020, which claimed priority from U.S. Provisional Patent Application No. 62/906,998, filed 27 Sep. 2019, both of which are hereby incorporated by reference in their entirety.

### INTRODUCTION

This disclosure generally relates to foam insulating panels or sheathing panels, such as those used on building walls or roofs.

### SUMMARY

A method of forming a building panel is provided. The method includes embossing dimples into a sheet, such that the dimples extend outward from a plane, and expanding a foam core onto the plane and into portions of the dimples. The method may include forming dimples that are convex relative to the plane and the foam core, and the sheet having a thin foil having a plastic protective coating.

The method may include attaching a cellulosic layer to the foam core opposite the plane and the dimples. Additionally, a plurality of flow channels may be formed in the sheet between the dimples, such that expanding the foam core onto the plane substantially fills both the dimples and the flow channels.

The method may include embossing dimples that are concave relative to the plane and the foam core, such that expanding the foam core onto the plane substantially fills the convex dimples, the concave dimples, and the flow channels. Expanding the foam core onto the sheet may bond the foam core to the sheet without additional adhesives or other attachment mechanisms.

The above features and advantages, and other features and advantages, of the present disclosure are readily apparent from the following detailed description of some of the best modes and other embodiments for carrying out the disclosure, which is defined solely by the appended claims, when taken in connection with the accompanying drawings.

### BRIEF DESCRIPTION OF THE DRAWINGS

FIG. 1 is a schematic, plan view of a building assembly with a plurality of foam panels assembled to a wall of a building.

FIG. 2 is a schematic, exploded view of an illustrative portion of a foam panel usable with building assemblies.

FIG. 3 is a schematic, side view of a portion of a foam panel having hexagonal dimples and usable with building assemblies, such as that shown in FIG. 1, showing that the foam fills the dimples.

FIG. 4 is a schematic, front view of another portion of a foam panel having hexagonal dimples and usable with building assemblies.

FIG. 5A is a schematic, front view of another portion of a foam panel having round dimples with flow channels formed therebetween usable with building assemblies.

FIG. 5B is a schematic, side view of a portion of a foam panel having round or spherical outward dimples usable with building assemblies showing that the foam fills the dimples and the flow channels.

FIG. 5C is a schematic, side view of a portion of a foam panel having a plurality of round or spherical outward first dimples and a plurality of inward second dimples usable with building assemblies showing that the foam fills the dimples and the flow channels.

FIG. 6 is a schematic, front view of another portion of a foam panel having spaced, round dimples usable with building assemblies.

### DETAILED DESCRIPTION

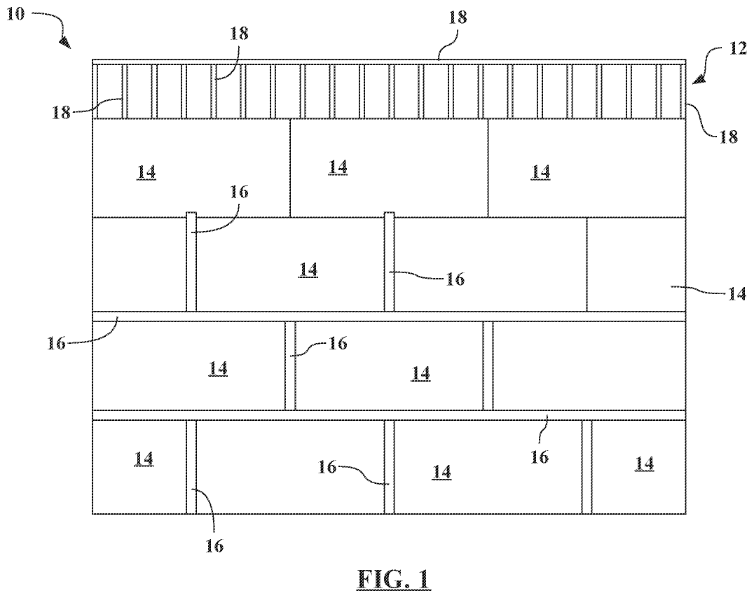

Referring to the drawings, like reference numbers correspond to like or similar components wherever possible throughout the several figures. FIG. 1 shows an illustrative portion of a building assembly 10 at least partially installed on a wall 12 of a building (not fully shown). Reference to the figures and the general description is exemplary of the following features, embodiments, or configurations, in addition to other features, embodiments, or configurations recognizable to skilled artisans.

A plurality of panels 14, are assembled to the wall 12. The panels 14 may also be referred to as foam panels 14, sheathing panels 14, building panels 14, or housing panels 14, depending on the configuration used in the building assembly 10 or the language used by skilled artisans. In the configuration shown in FIG. 1, the panels 14 are butted against one another and several of the joints are covered with joint tape 16, such as flashing tape or seam tape, which generally creates a waterproof assembly over the wall 12, when properly installed, as recognized by skilled artisans. Some configurations may not require the joint tape 16.

The panels 14 may be formed in 4-foot by 8-foot rectangles, other common sizes, or custom formed to fit specific applications, such as covering the entire wall 12 with a single panel 14. In many configurations, the panels 14 will be configurated, as recognized by skilled artisans, to provide shear bracing, continuous insulation, transverse wind resistance, and an air and water-resistive barrier.

The panels 14 may be attached to the wall 12 via fasteners (not shown) driven into a plurality of framing members 18, which may be formed from wooden, metal, or other suitable framing materials. The wall 12 may also be formed from concrete or masonry, with the panels 14 appropriately attached thereto, as would be recognized by skilled artisans.

While the building assembly 10 may be illustrated and discussed relative to vertical, or substantially vertical, exterior walls 12, it may also be applied to sloped walls or roof structures. Additionally, the building assembly 10 may be installed on interior, or partially exterior, walls, and may be used above or below grade.

In practice, the panels 14 may be covered by a plurality of siding or cladding elements that provide aesthetic and functional finishing of the building. The siding elements interacting with the building assembly 10 may be numerous types of siding or roofing products. The siding elements may include, without limitation: natural wooden shakes or shingles; natural, artificial, or composite plank or lap siding; metal siding; wooden, slate, or asphalt shingles; stone or brick veneer; or fibrous cement panels.

While the present disclosure may be illustrated with respect to particular industries or applications, those skilled in the art will recognize the broader applicability of the products and methods described herein. For example, similar structures, methods, or combinations thereof, may be used in other industries, including, without limitation: residential, commercial, or industrial structures.

Those having ordinary skill in the art will also recognize that terms such as “above,” “below,” “upward,” “downward,” et cetera, are used descriptively of the figures, and do not represent limitations on the scope of the appended claims. Any numerical designations, such as “first” or “second” are illustrative only and are not intended to limit the scope of the claims in any way.

When used herein, the term “substantially” refers to relationships that are ideally perfect or complete, but where manufacturing realties prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans would recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting.

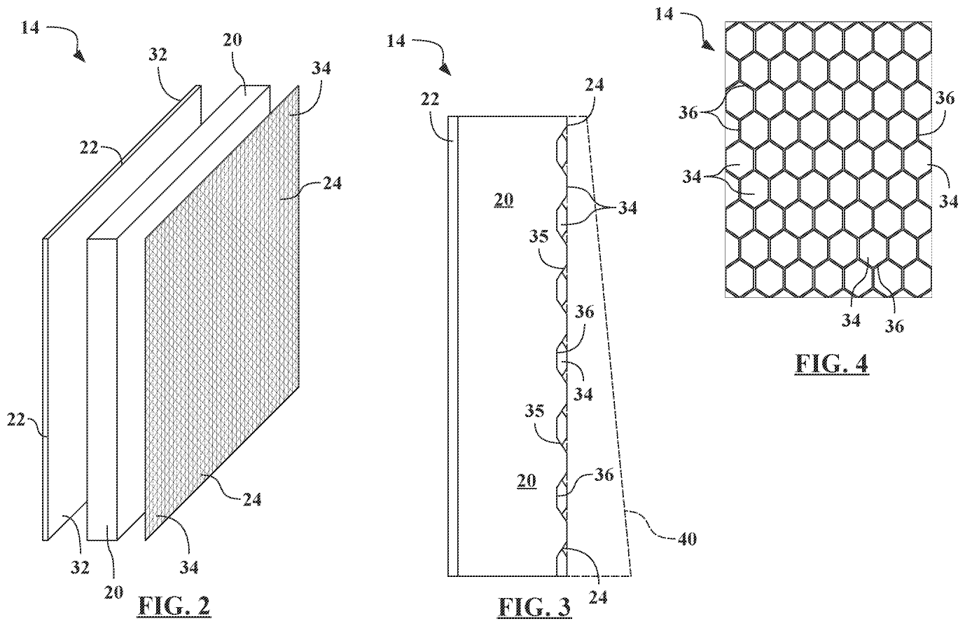

Referring also to FIGS. 2, 3, and 4, and with continued reference to FIG. 1, there are shown additional views of example panels 14. FIG. 2 shows a schematic, exploded view of a portion of one of the panels 14; FIG. 3 shows a schematic, side view of a portion of one of the panels 14; and FIG. 4 shows a schematic, front view of a portion of one of the panels 14. The components shown in FIGS. 2-4 may be different embodiments of panels 14 shown in FIG. 1, and may also be illustrating alternative features.

As shown in the figures, the panels 14 may be formed from a plurality of layers. The views shown in the figures are illustrative only, and additional, or fewer, layers may be used to form the panels 14.

A foam core 20 is located between a cellulosic layer 22 and a drainage plane 24 on the opposite side of the foam core 20 from the cellulosic layer 22. The cellulosic layer 22 may improve the structural strength and resistance to shear of the wall 12. However, many configurations of the panels 14 may not include the cellulosic layer 22, such that the panel 14 is formed from the foam core 20 and the drainage plane 24—possibly with additional layers or features.

The foam core 20 acts as insulation and adds a thermal barrier to the building assembly 10. The foam core 20 may also provide structural benefits. The foam core 20 may be formed from a closed-cell, moisture-resistant, polyisocyanurate (polyiso) foam. The foam core 20 provides high compressive strength, a long-term R-value, and a continuous air barrier.

The foam core 20 may be formed by expanding foam between the cellulosic layer 22 (or any other layers included in the panels 14). In configurations that do not include the cellulosic layer 22, the foam core 20 may be expanded between a die plate and the drainage plane 24, or between an additional film or facer layer and the drainage plane 24. In alternative configurations, the foam core 20 may be preformed to any of its available thicknesses, and then have the cellulosic layer 22, the drainage plane 24, or both, attached or adhered thereto.

The cellulosic layer 22 may be formed from pressure laminated plies having high-strength cellulosic fibers. Furthermore, the fibers and the binder incorporated into the cellulosic layer 22 may be specially treated to be water resistant and may be bonded with a water-resistant adhesive. Therefore, the binder and the fibers may form an air and water-resistive barrier (WRB) within the cellulosic layer 22 and the drainage plane 24.

The panel 14 may also include one or more barrier layers or facers, which further limit passage of air and water vapor through the panel 14. The air and water-resistive barriers may be located in different, and multiple, portions of the panel 14. In FIG. 2, there is a barrier layer 32 illustrated as part of the cellulosic layer 22. The barrier layer 32 limits or minimizes passage of air, water, and water vapor through panels 14, and may be located in different portions of the panels 14. Furthermore, additional barrier layers may be incorporated into other portions of the panels 14.

In some configurations, the barrier layer 32 may be a facing adhered to one or more sides of the foam core 20. When the barrier layer 32 forms part of the foam core 20, the air and water-resistive capabilities of the foam core 20 are enhanced over the foam alone. The foam material, itself, may also limit passage of air and water through the panels 14.

As shown in FIGS. 2-4, the drainage plane 24 is attached to one side of the foam core 20, generally the exterior or outward side, relative to the building interior. The drainage plane 24 may be formed from a film made with foil, plastic, or combinations thereof. For example, and without limitation, the drainage plane 24 may be formed from a thin foil (possibly a reflective foil) with a clear protective coating. Alternatively, the drainage plane 24 may have several layers, including, without limitation: coated foil layers, paper or paper-like layers, PET (Polyethylene terephthalate) layers, or various combinations thereof. The drainage plane 24 may also be referred to as a facer or facer layer and is likely to be formed from, for example, and without limitation, either foil or foil plus PET. Note that either, or both, sides of the panels 14 may be printed or painted with logos, technical specifications, or installation instructions.

The drainage plane 24 may be embossed or otherwise shaped to create a three-dimensional profile, as shown in the figures. A plurality of dimples 34 are formed in the drainage plane 24 and extend outward from the foam core 20. A plurality of flow channels 36 are thereby formed between the dimples 34 and are recessed relative to the outwardly extended dimples 34. The dimples 34, and other examples, shown in the figures, are illustrative only. Note that the drainage channels or flow channels 36 are formed by the areas of the drainage plane 24 that do not include the dimples 34.

As illustrated in FIG. 3, the panels 14 may have a cladding layer or cladding 40 attached to the outside. The cladding 40 generally completes the building assembly 10 by adding an aesthetic and/or functional finishing layer—although the cladding 40 may also be painted or otherwise treated—and may incorporate the previously discussed siding elements. That the cladding 40 shown is illustrative only, and may be numerous shapes and sizes and configurations, including those listed above and others, as will be recognized by skilled artisans.

In many configurations of sheathing or foam panels, there would need to be either spacing members or a separate building wrap placed between the cladding 40 and the sheathing or foam panels. However, the panels 14 may have the cladding 40 pressed directly against the dimples 34 of the drainage plane 24.

The dimples 34 provide separation between the cladding 40 and portions of the drainage plane 24, particularly the flow channels 36. Therefore, water or moisture that finds its way between the cladding 40 and the drainage plane 24 is able to flow downward (relative to gravity and to the view of FIGS. 2-4) through the flow channels 36. Flashing or other elements (not shown) may assist in removing drained water from the panels 14, or the water may simply fall downward after leaving the panels 14. Importantly, any water between the foam core 20 and the cladding 40 is able to move downward, as opposed to staying within the panel 14 or moving into the building, and is able to do so without the addition of dedicated spacer elements or additional wrap layers.

The drainage plane 24 may be formed by embossing the dimples 34 into a sheet of foil film, or other suitable materials. Depending on the configuration, the flow channels 36 may be positively formed or may be the un-embossed portion of the original sheet material.

As viewed in FIG. 4, the flow channels 36 of the drainage plane 24 define both vertical and horizontal moisture pathways, relative to gravity. This provides two directions of flow, and differentiates from an alternative system that has only vertical channels or vertical grooves, such as vertical firing strips located between the foam and the cladding. In the configuration shown in FIGS. 3 and 4, the dimples are formed in a honeycomb or hexagonal shape. Therefore, the horizontal pathways provided by the flow channels 36 are angled between 30-60 degrees relative to the vertical pathways, such that they still promote downward flow of water. The staggered configuration of the dimples 34 also differentiates over vertical features, and allows more support between elements than vertical firing strips and the like.

Note that the tightly spaced pattern of the dimples 34 is illustrative only. Some configurations may have fewer dimples 34 and/or widely spaced dimples 34. In configurations with fewer dimples 34, the flow channels 36 may be partially formed by flat areas between the dimples 34, which may form a substantially planar structure between the dimples 34.

As viewed in FIG. 3, the foam core 20 extends into a convex surface 35 defined by each of the plurality of dimples 34, such that the back sides of the dimples 34 are substantially filled by the foam material. This configuration may be achieved by either forming the foam with the same dimple shapes as the drainage plane 24, or by using rising or expanding foam that expands into convex surfaces 35 of the dimples 34 during formation of the panels 14.

The foam-filled dimples 34 may further enhance the strength of the drainage plane 24 against the pressure of the cladding 40 or other exterior attachments, such that the dimples 34 are less likely to be compressed or collapsed and the flow channels 36 more likely to remain open. Additionally, because the free rise foam bonds to the convex surfaces 35 on the back side of the dimples 34, the drainage plane 24 may be attached to the foam core 20 without added glue, adhesives, or fasteners because the free rise foam bonds or adheres itself directly to the drainage plane 24. Direct bonding of the free rise foam core 20 allows the panels 14 to be assembled with fewer processes and with fewer components.

Note that the free rising foam may not completely, or entirely, fill the convex surfaces 35 of the dimples 34. However, the foam coverage within the dimples 34 would be substantially filling the dimples 34 if it is sufficient to both bond the drainage plane 24 to the foam core 20 and to support the dimples 34 against the pressure of the cladding 40.

In FIG. 1, the panels 14 are butted against one another and covered with joint tape 16 to create a waterproof assembly over the wall 12. To limit incursion of water or moisture into the building, the seams between the panels 14 will likely be sealed in some fashion. In addition to the joint tape 16, other options may include, without limitation, caulking, adhesives, or injectable sealants.

In other configurations, the panels 14 may be installed with a slight overlap, in lieu of the joint tape 16, to form the waterproof assembly. In some configurations, the drainage plane 24, for example, may extend somewhat beyond the foam core 20 on one or two edges of the panels 14. In such configurations, the foam cores 20 of adjacent panels 14 may abut one another, but the drainage plane 24 of one panel 14 would overlap the drainage plane 24 of the adjacent panel 14, creating a lapped installation that may minimize water intrusion.

In other configurations, the panels 14 may have edge portions of the drainage plane 24 that are formed without the dimples 34, or with widely spread dimples 34. With flat edges or fewer dimples 34 on the edges, it may be easier to apply the joint tape 16 to seal the seams between the panels 14. Additionally, flashing elements may be used at the seams between the panels 14 to seal the building assembly 10.

In some configurations, the panel 14 may further include a reflective layer (not separately shown). The reflective layer may be a single or double-sided reflective foil surface, or a multi-layer surface partially formed from foil or other reflective materials, and may be located on different portions of the panel 14. In some configurations, the reflective layer may be attached to the foam core 20 opposite the drainage plane 24, such as between the cellulosic layer 22 and the foam core 20 or in lieu of the cellulosic layer 22. Furthermore, the reflective capabilities may be part of the foil film layer incorporated into the drainage plane 24, such that the drainage plane 24 has reflective characteristics.

In most configurations of the panels 14, such as that schematically illustrated in the figures, the cellulosic layer 22 will be placed toward the interior of the building, with the drainage plane 24 facing the exterior. However, other configurations may be used, such as with the drainage plane 24 toward the interior of the building.

The preformed panels 14 may be attached to the wall 12 with various fasteners, as would be recognized by those having ordinary skill in the art. For example, and without limitation: nails or staples may be used to attach the panels 14 to wooden framing members 18, and self-drilling screws may be used to attach to metal framing members 18.

Note that various fasteners may be used to attach the cladding 40 to the panels 14 and the wall 12, as would be recognized by skilled artisans. Additionally, the foam core 20, the cellulosic layer 22, and the drainage plane 24 of the panels 14 may provide enhanced sealing between the fasteners and the panels 14, relative to standard applications, such that neither gaskets nor sealants are required at the interface of the panels 14 and any of the fasteners.

Note that most applications of the panels 14 do not require additional layers, such as house or building wraps, for air and water resistance. The foam core 20 of the panels 14 may provide enhanced sealing around the fasteners used to attach the panels 14 to the wall 12, which further improves the insulating capabilities of the building assembly 10.

The configurations and/or embodiments shown in the figures may not be shown to scale. The panels 14 may be formed with different layer configurations, and, also, formed with different thicknesses of the components. The examples given below, as well as those shown in the figures, are illustrative of only a few possible configurations. For example, and without limitation, the foam core 20 may range in thickness from 0.50 inches to 4.0 inches. Furthermore, the R-values of the foam core 20, alone, may range from 3.0 to 25.0 or more.

The thickness of the cellulosic layer 22, when included in the panel 14, may range from, for example, and without limitation, 0.078-0.135 inches. Note that manufacturing variability may result in thicknesses outside of the ideal sizes. The resulting, combined, R-values of the panels 14 may be greater than that of the foam core 20 alone. Furthermore, because the cellulosic layer 22 and the drainage plane 24 add air and water barriers, the effective insulating value of the panel 14 may be increased.

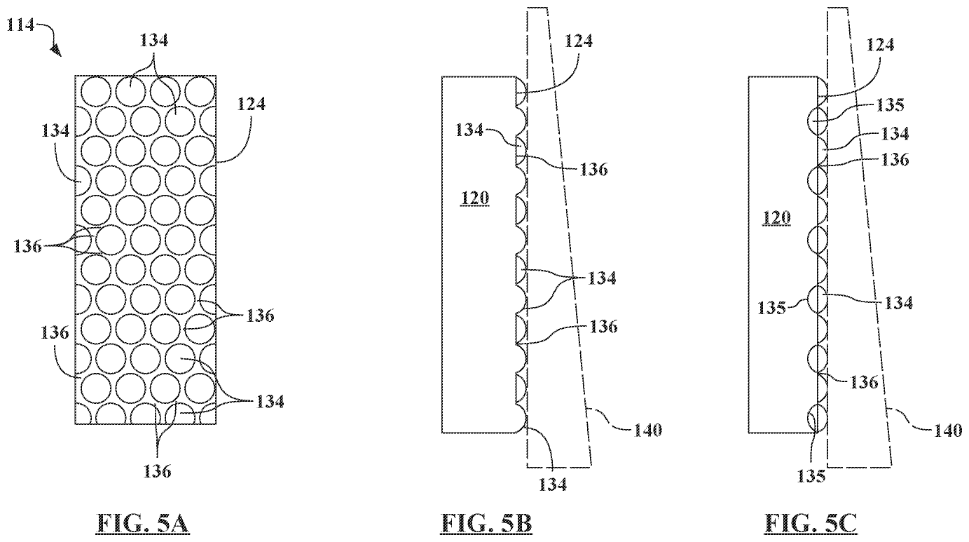

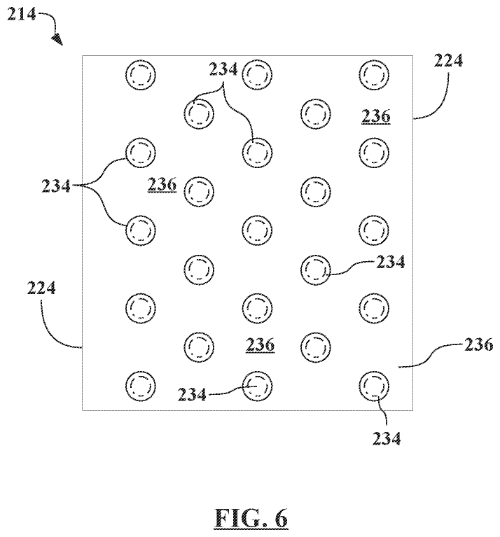

Referring also to FIGS. 5A, 5B, and 5C, and with continued reference to FIGS. 1-4, there are shown additional views of exemplary foam panels. FIG. 5A is a schematic, front view of a portion of another foam panel, or simply panel 114, having a drainage plane 124 with a plurality of round dimples 134. FIG. 5B is a schematic, side view of a portion of the panel 114, showing the round or spherical dimples 134 extending outward. FIG. 5C is a schematic, side view of a portion of the foam panel 114, but configured with both first outward dimples 134 and second inward dimples 135. Each of the illustrated panels 114 may be used with building assemblies, such as that shown in FIG. 1.

The drainage planes 124 shown in the figures are attached to a foam core 120, which may be formed from free rising foam that extends into convexities on the back side of the outward dimples 134, which are convex to the foam core 120. A plurality of flow channels 136 are formed between the dimples 134.

The panels 114 may also be formed by embossing the drainage plane 124 after it is attached, as a flat sheet or film, to the foam core 120. Therefore, the dimples 134 and the flow channels 136 may be formed substantially simultaneously in both the drainage plane 124 and the foam core 120.

In the configuration shown, the panels 114 have both vertical and horizontal flow paths. A cladding layer or cladding 140 may be attached to the panels 114. The flow channels 136 are offset from the cladding 140 by the dimples 134 of the drainage plane 124. Therefore, water between the cladding 140 and the panels 114 can flow downward (relative to gravity) and is not trapped between the components.

Although several of the examples illustrated herein have outward dimples—i.e., extending away from the foam—the configuration of FIG. 5C also has inward, or second, dimples 135. In the configuration of FIG. 5C, the inward dimples 135 may provide further spacing between the foam core 120 and the cladding 140.

The inward dimples 135 are concave relative to the foam core 120. The outward dimples 134 will space to cladding 140, such that any water that moves between the foam core 120 and the cladding 140 will flow downward via the flow channels 136 and also the inward dimples 135 and be removed from the panels 114.

Although only rounded dimples 134 and hexagonal dimples 34 are illustrated herein, additional shapes and configurations may be used with the panels. For example, and without limitation, drainage planes 124 with differently sized dimples, differently spaced dimples, as well as different shapes of dimples may be used on the same plane.

Referring also to FIG. 6, and with continued reference to FIGS. 1-5C, there is shown an additional view of a portion of a panel 214 having of a drainage plane 224 with a plurality of round dimples 234. The dimples 234 shown in FIG. 6 have greater spacing than those of the other drainage planes shown in the figures. A plane of flow channels 236 is formed between the dimples 234.

For example, and without limitation, the pattern of the dimples 234 may be spaced between 0.5-0.75 inches, center to center. The diameter may be, for example, between 0.2-0.30 inches and the dimples 234 may be offset convexly from the plane by 0.015-0.030 inches. The depth of the embossed elements—dimple shaped elements on, for example, rollers—may be greater than the resulting dimple depth, in order to account for return or spring back of the material forming the drainage plane 224. The foam core (not viewable in FIG. 6) would extend into the back side of the convex dimples 234. The dimples 234 may be offset from row to row by, for example, between 0.30-0.40 inches. In some configurations, depending on the cladding (not shown) and fasteners (not shown) used, some portions of the plane of the flow channels 236 may contact the cladding. However, moisture would still be able to flow through other areas of the flow channels 236.

Methods of making panels similar to those described herein may include embossing a sheet of thin foil having a plastic protective coating and forming dimples in the sheet via the embossing. Depending on the material forming the drainage plane, the embossing elements may result in the final shape of the dimples or there may be some return or give—such that foil plus PET drainage planes are likely to have dimples with lesser depth than drainage planes formed from foil alone. Then, the formed drainage plane may have free rise foam expanded onto it, such that the convex portions of the dimples are (at least partially) filled. In many situations, the free rise foam will substantially fill the dimples (whether convex or concave) and the drainage channels therebetween. Additional layers, such as cellulosic layers, other protective coatings, or reflective foils may then be applied, in addition to printing branding and/or instructions onto the panels.

The detailed description and the drawings or figures are supportive and descriptive of the disclosure. While some of the best modes and other embodiments for carrying out the disclosure have been described in detail, various alternative designs, configurations, and embodiments exist for practicing the appended claims.

1. A method of forming a building panel, comprising:
embossing dimples into a sheet, such that the dimples extend outward from a plane; and
expanding a foam core onto the plane and into portions of the dimples, to thereby form the building panel.

2. The method of claim 1, wherein the dimples are convex relative to the plane and the foam core.

3. The method of claim 2, wherein the sheet is a thin foil having a plastic protective coating.

4. The method of claim 3, further comprising:
attaching a cellulosic layer to the foam core opposite the plane and the dimples.

5. The method of claim 4,
wherein a plurality of flow channels are formed in the sheet between the dimples, and
wherein expanding the foam core onto the plane substantially fills the dimples and the flow channels.

6. The method of claim 1,
wherein a plurality of flow channels are formed in the sheet between the dimples, and
wherein expanding the foam core onto the plane substantially fills the dimples and the flow channels.

7. The method of claim 2,
wherein a plurality of flow channels are formed in the sheet between the dimples, and
wherein expanding the foam core onto the plane substantially fills both the dimples and the flow channels.

8. The method of claim 7, further comprising:
embossing dimples that are concave relative to the plane and the foam core,
wherein expanding the foam core onto the plane substantially fills the convex dimples, the concave dimples, and the flow channels.

9. The method of claim 1, wherein expanding the foam core onto the sheet bonds the foam core to the sheet without additional adhesives.

10. The method of claim 1, wherein the sheet is a thin foil having a plastic protective coating.

11. The method of claim 1, further comprising:
attaching a cellulosic layer to the foam core opposite the plane and the dimples.
